(19) United States
(12) Patent Application Publication
(10) Pub. No.: US 2025/0067114 A1
(43) Pub. Date: Feb. 27, 2025

(54) SPACER FOR PANES AND ARRANGEMENT

(71) Applicant: Kyocera Fineceramics Europe GmbH, Mannheim (DE)

(72) Inventors: Krishna UIBEL, Speyer (DE); Christian FILZ, Lampertheim (DE); Stefan VELTEN, Heidelberg (DE); Sarah DENKHAUS, Gernsheim (DE)

(73) Assignee: Kyocera Fineceramics Europe GmbH, Mannheim (DE)

(21) Appl. No.: 18/692,348

(22) PCT Filed: Aug. 17, 2022
(86) PCT No.: PCT/EP2022/072910

§ 371 Date: Mar. 15, 2024

(30) Foreign Application Priority Data
Sep. 17, 2021 (DE) 10 2021 124 102.2

(51) Int. Cl. E06B 3/663

(52) U.S. Cl. CPC E06B 3/66304

(57) ABSTRACT

The invention relates to a spacer (1) for arrangement between two panes (2), in particular for arrangement between two glass panes of double-glazed or multi-glazed windows or doors, comprising a main body (3) having two axially opposing contact surfaces (4) each for contacting a pane (2). With regard to the problem of specifying an arrangement having a spacer between two panes, in particular two glass panes, in which the stress profile in the surroundings of a contact surface, at least in the glass, indicates a profile that is overall as even and as low as possible, in other words, stress peaks that could damage a pane are reduced or avoided as far as possible, the spacer is characterised in that at least one deformable deformation zone (5) is arranged between the contact surfaces (4), to which deformation zone are allocated doming means which give the contact surface (4) a domed shape.

The invention relates to a spacer for panes, in particular for glass panes of double-glazed or multi-glazed windows or doors, according to the preamble of claim 1, and to an arrangement comprising at least one such spacer and two panes lying against it.

US 2018/0 066 469 A1 discloses spacers for panes, having rounded or beveled corners and steps in the form of grooves. This document also discloses that the spacers may be ceramic and may have a functional coating.

Against this background, US 2015/0 079 313 A1 discloses a functional coating which is capable of yielding and is applied to a main body of the spacer to smooth its surface.

Finally, U.S. Pat. No. 10,550,627 B1 discloses a spacer having a stepped surface and the effect, by a functional coating, of smoothing the surface and also avoiding glass damage.

Against this background, it is known from the prior art to produce double-glazed or triple-glazed windows or doors. The intermediate space between the glass panes can be filled with a gas, preferably an inert gas, in order to meet certain specifications regarding the thermal conductivity or the sound insulation. However, it is particularly advantageous in terms of the thermal conductivity and the sound insulation if there is a vacuum between the glass panes.

A vacuum between the glass panes in turn leads to a negative pressure in relation to the atmospheric pressure, which leads to a considerable load on the glass panes. The larger the area of a glass pane, the higher the force is that the atmospheric pressure exerts on a glass pane. When certain loads are exceeded, glass panes bend in the direction of the vacuum to such an extent that they break.

In order to counter this problem, it is known from the prior art to arrange spacers between the glass panes, the spacers supporting the glass panes against each other predominantly at a certain point or points.

In this case, a spacer lies with its one end by means of a contact surface against a glass pane and with its other end by means of a contact surface against the opposite glass pane.

In practice, it may be necessary to arrange a very large number of spacers between two large-area glass panes, with each spacer being pressed very strongly against the glass panes at contact areas by the atmospheric pressure. At the contact areas, in particular in the area of borders, tips or edges of a spacer, stress peaks may occur both in the glass and in the spacer and may lead to damage, in particular of the glass panes.

The invention is therefore based on the object of specifying an arrangement with a spacer between two panes, in particular two glass panes, in which the stress curve in the vicinity of a contact surface, at least in the glass, is overall as uniform and low as possible, i.e. stress peaks, which may damage a pane, are reduced or avoided as far as possible.

The present invention achieves the above-mentioned object by the features of the independent claims.

According to the invention, it has been recognized that a contact surface has to have or assume a most ideal dome shape in order as little as possible to load a pane which lies against it under pressure.

Owing to this dome shape, which preferably only arises as a relief geometry when a pane presses against the spacer, stress peaks due to borders or sharp material jumps are reduced or even avoided particularly at an edge of a main body.

This is the case because the pane lies almost only or only against the dome-like contact surface of the main body, which contact surface is compressible owing to the deformation zone associated with it.

Furthermore, it has been recognized that the contact surface can be deformed under pressure by a suitable formation or structuring of it per se, or of the deformation zone delimited axially outward by it, such that the curvature of the pane resulting in the region of the spacer under pressure stresses is ideally placed against the dome of the spacer and a particularly advantageous pressing between the pane and the spacer can arise. With said pressing, the maximum pressure or the maximum stress is minimized according to the invention.

According to the invention, it has finally been recognized that the spacer has to have a cap-like structure which is substantially rotationally symmetrical or formed by regularities or a relief of this type, which cap-like structure or relief, unless it imparts an ideal dome shape to the contact surface even without the application of a pane, transfers said contact surface at least into such a dome shape when a pane applies pressure to it.

The means could guide the deformation zone at least as far as the peripheral edge of the main body and extend the dome shape of the contact surface as far as the peripheral edge in such a way that the contact surface, and therefore the main body, is axially deformable at its peripheral edge. This makes it possible for the contact surface to overlap the hard edge of a relatively hard and almost incompressible material lying beneath it, such that a pane does not come into contact with said hard material.

Alternatively, the contact surface could be spaced apart from a peripheral edge in such a way that a pane does not come into contact with the hard edge. For the spacing, a step, preferably a circumferential step, could be provided at the edge region.

The means could be arranged symmetrically and/or regularly with respect to an axis, in particular longitudinal axis or axis of symmetry of the main body, through the center of the contact surface such that they form points which are diametrically opposite with respect to the axis and which lie on the imaginary or real surface of a spherical cap or on a circular arc with a radius of curvature, which is on average in the range of 0.5 mm to 100 mm, preferably 0.7 mm to 70 mm, further preferably 0.8 mm to 50 mm, further preferably 1 mm to 45 mm, further preferably 1.5 mm to 20 mm, further preferably 2 mm to 30 mm or 0.3 mm to 50 mm, further preferably 0.5 mm to 45 mm, further preferably 0.8 mm to 30 mm or 2 mm to 200 mm, further preferably 3 mm to 100 mm and particularly preferably 5 mm to 80 mm.

A rotational symmetry or lateral regularity of the means permits the setting of an ideal end geometry. The end geometry can be achieved starting from an initial geometry, which can be defined or described by a radius of curvature which clearly defines a spherical cap or a circular arc in cross section, said spherical cap or circular arc axially limiting, encasing, or passing through a structuring of the spacer, or passing through the functional focal points thereof. It is quite essential that the radius of curvature is an initial radius of curvature which can be transferred into a smaller, preferably a larger or constant, end radius of curvature of the contact surface because the contact surface preferably undergoes a convex flattening when a pane presses against it.

The end radius of curvature which arises under pressure loading in the installed state is on average ≥1 mm, preferably ≥2 mm, further preferably ≥3 mm, further particularly preferably ≥5 mm. In all the aforementioned cases, the end radius of curvature is either ≤50 mm or ≤40 mm. The shape of the radius is preferably rotationally symmetrical, but may also deviate from the rotational symmetry.

The means could comprise step edges and/or step surfaces and/or dome portions and/or a dome, which are or is introduced in a core material of the main body of lower deformability and/or in a coating of the core material of higher deformability. Steps can be used to create pyramid-like or frustoconical, preferably spherical-segment-shaped, elevations that are deformed into a dome when a pane presses against them.

The structures introduced into the main body and/or the coating have heights/depths which are on average ≥0.1 μm, preferably ≥0.2 μm. In all the aforementioned cases, the heights/depths are ≤20 μm, preferably ≤15 μm, further particularly preferably ≤10 μm. The structures introduced may also have average heights/depths of 0.3 μm±0.1 μm, 0.4 μm±0.1 μm or 0.5 μm±0.1 μm.

The structures introduced into the main body and/or the coating have widths/diameters which are on average ≥1 μm, preferably ≥5 μm. In all the aforementioned cases, the widths/diameters are ≤300 μm, preferably ≤200 μm, further particularly preferably ≤100 μm. The structures introduced can also have average widths/diameters of 20 μm±5 μm, 30 μm±5 μm.

The number of steps in the coating and/or in the core material is ≥1, ≥2, further ≥3, further ≥4. In all the aforementioned cases, the number is ≤50. The falling or rising of the contact surface may merge at the limit into a curve following a radius of curvature.

The structuring of the main body and/or of the coating may also be carried out in such a way that a contact surface following a radius of curvature is formed with an average height difference between the center and edge region of the spacer of ≥0.1 μm, preferably ≥0.2 μm, further preferably ≥1 μm, further particularly preferably ≥2 μm. In all the aforementioned cases, the height difference is ≤20 μm, preferably ≤15 μm, further particularly preferably ≤10 μm. The introduced removal may also have an average height difference between the center and edge region of 1 μm±0.5 μm, 2 μm±0.5 μm or 3 μm±0.5 μm.

The deformation zone could comprise a coating which has a higher deformability than a core material, wherein the means comprise coating portions which follow one another in a step-like manner and gradually taper in their width toward a coating dome or coating peak, wherein the coating dome or coating peak forms an axially outermost coating portion, which can be turned toward a pane. In such a case, an elevation could preferably be formed from a coating which rests on a flat surface of a core material. Thus, a surface of a core material can be well covered completely, and therefore its hard edges or edge points are no longer contactable by the pane.

The deformation zone could comprise a coating which has a higher deformability than the core material, wherein the means comprise core material portions which follow one another in a step-like manner and taper in their width toward a core material dome or core material peak, wherein the core material dome or core material peak forms an outermost core material portion, which can be turned toward a pane, and wherein the coating covers and/or surrounds the core material dome or core material peak. Owing to this configuration, the hard core material already approximately predetermines the dome shape.

The coating could cover and/or enclose at least one or more core material portions. Thus, a relatively thin coating can only just form an envelope or encasement of the hard core material, which envelope or encasement, in contrast to the core material, can be further flattened such that the final dome shape arises under pressure of a pane.

Preferably in all previously described embodiments, the end radii of curvature of the domes were only able to be formed under pressure of the pane. In an embodiment in which a uniform layer thickness of a coating is present on a preformed dome of the core material, the end radius of curvature could already be completely or almost completely formed. In this special embodiment, only the steps of an envelope of the core material would be compensated for, so to speak, and therefore a substantially round dome is formed.

The means could comprise recesses which extend from a surface of the core material into the interior thereof, wherein the recesses are at least partially filled with a coating on the core material or can be filled by pressurization of the contact surface, wherein the coating has a higher deformability than the core material. By means of recesses or accumulations or clusters of such recesses appropriately arranged regularly or symmetrically, it is possible to produce mean functional layer thicknesses of the coating, which, in combination with the core material of the contact surface, impart a dome shape when a pane presses against the contact surface.

Such recesses can be in the form of bores, blind holes, hollows, or cavities with a linear, circular, angular, serrated, meandering, helical, spiral or honeycomb-like form, or in the form of portions of said forms. It is also conceivable that the recesses are formed by mixed forms of the aforementioned depressions or by portions of the depressions.

The depth and/or lateral width of the recesses and/or the lateral extensions thereof that may be present in some sections could increase or decrease from a center of the contact surface radially and laterally outward. Advantageously, the depth and/or width of recesses and/or lateral extensions increase(s) in the direction of the edge of the main body, and therefore the material of a coating can deviate to a greater extent axially downward or laterally outward when a pane presses against the coating axially from above. It is thus possible to assist the formation of a dome shape of the contact surface in an edge region.

The thermal conductivity of the main body is ≤15 W/mK, preferably ≤5 W/mK, further preferably ≤3 W/mK, further particularly preferably ≤1 W/mK, in the axial direction. For all the abovementioned regions, the thermal conductivity is at least 0.01 W/mK.

A core material lying inside the main body could comprise an inorganic material, e.g. a metal or a glass or a ceramic or a glass ceramic. A glass, a ceramic or glass ceramic can form the hard, relatively incompressible core of a main body, in particular a pillar, which is at least partially covered at its opposite longitudinal ends with a coating.

A glass, a ceramic or a glass ceramic has much lower thermal conductivity than a metal.

The porosity of a ceramic main body should be on average ≥1%, preferably ≥2%, further preferably ≥5%, further particularly preferably ≥10%. In all the aforementioned cases, the porosity is ≤50%, preferably ≤40%, further particularly preferably ≤30%. The porosity may also be 10%±5%, 20%±5% or 30%±5% on average.

Recesses can be produced chemically, for example by plasma etching, mechanically or by using electromagnetic or particulate radiation.

Laser processing is preferred, as it allows the most delicate structures to be introduced reliably and in a clearly defined manner.

A coating could comprise a microporous material, in particular a microporous ceramic and furthermore, in particular, a nanoporous, glassy or glass-ceramic material.

These materials are preferably applied to the core material as a coating suspension:
in particulate form in a dispersing medium, such as water or ethanol, or
in a mixture with a sol-gel binder, or
as a pure sol-gel system.

The particulate systems comprise particles with mean particle sizes <10 μm, preferably <5 μm, further preferably <2 μm and particularly preferably <1 μm, but preferably substantially ≥100 nm, and a dispersing medium.

The sol-gel systems include molecules of organometallic compounds or salts of metals or nanoparticles as precursors of a ceramic, or ceramic nanoparticles with a particle size of less than 100 nm, or mixtures thereof.

The sol-gel systems are liquid systems which comprise molecules of precursors of oxide ceramics or glasses, i.e. organometallic compounds or nanoparticles of precursors of oxide ceramic or glass-forming components, or nanoparticles of oxide ceramic or glass-forming components, or
a) mixtures of molecules of different precursors, or
b) mixtures of nanoparticles of different precursors, or
c) mixtures of nanoparticles of ceramic or glass-forming components, or mixtures of mixture variants a) and b) or mixtures of mixture variants b) and c) or mixtures of mixture variants a) and c) or mixtures of mixture variants a), b) and c).

The sol-gel systems may be water-based or solvent-based.

The molecular precursors may comprise organometallic compounds (e.g. aluminum isopropoxide or tetraethyl orthosilicate) or already partially pre-condensed commercially available sol-gel systems (e.g. inosil, Inomat GmbH, Neunkirchen, Germany) or salts (e.g. zirconium acetate) or hydroxides and/or oxyhydroxides of metals (e.g. aluminum). During a temperature treatment, the precursors oxidize into ceramics starting at temperatures below 300° C. and temperatures below 400° C. in air.

The systems mixed with particulates or pure sol-gel systems are applied to the core material by dip coating, spray coating, application by squeegee, screen printing, spinning, doctor blade, slot die, electrophoresis or other procedures. Preferred application variants are spraying, screen printing, electrophoresis, application by squeegee, slot die and doctor blade.

The coating systems are solidified by drying. Preferably, the coatings are further solidified during a temperature treatment.

Further preferably, the temperature treatment of the coating is baked at >50° C., preferably >80° C., further preferably >100° C., further preferably >150° C., further preferably >200° C., further preferably >250° C., further preferably >300° C., further preferably >350° C., but at less than 1300° C., preferably at less than 1000° C., preferably at less than 800° C.

During the temperature treatment, the coating solidifies so that it is stable for transport and/or is preferably additionally converted into a purely inorganic material. The coating is more strongly compressible than the core material.

Vapor deposition, CVD and PVD are less preferred methods.

The coating may comprise other organic or inorganic particulate components that modify the deformability, hardness, porosity, or stability of the coating. These components can be metal particles, graphite, hexagonal boron nitride, soot, polymethyl methacrylate (PMMA), polytetrafluoroethylene (PTFE), tungsten or tungsten oxide, for example in the form of microspheres, irregularly shaped particles, fibers, platelets or agglomerates, or mixtures thereof.

The material of the coating could therefore be inorganic or substantially inorganic. However, it could also be organic, metallic or of glass or be a mixed form. Furthermore, it may be both porous and dense, or formed with a gradient in the porosity.

The embodiment which is described below and in which the material of the coating is arranged on both sides of the spacer, and structures, in particular steps, are attached, preferably mirror-symmetrically, in the spacer, is preferred. Strict symmetry is not necessary as long as only the dome shape is attainable.

The material of the coating may have further properties, with it not being necessary for both sides of the spacer to have the same properties. Thus, the material of the coating can be colored, electrically conductive or insulating, magnetizable, hydrophilic, hydrophobic, of the same or different density on both sides, or adhesive per se or by means of embedded particles. The porosities of the coatings on both sides of the spacer may also differ.

Functionalization of the coating can have a positive influence in particular on the positioning of the spacers on the pane. Additional temporary coatings can also be applied shortly before application to increase adhesion (e.g. water, ethanol, cyclododecane).

The volume reduction of the deformation zone and/or of a coating on the core material could be on average in the range of 0.01 to 0.7, preferably 0.02 to 0.6, further preferably 0.03 to 0.5, further preferably 0.05 to 0.45, further preferably 0.05 to 0.4 or 0.01 to 0.4, more preferably 0.02 to 0.3, further preferably 0.035 to 0.25 or 0.01 to 0.3, further preferably 0.02 to 0.25, and particularly preferably 0.035 to 0.2. These volume reductions are advantageous when a glass pane is placed onto a spacer of the type described here. The value 0.01 corresponds to a compression of 1% from an initial volume to a final volume.

The diameter of the main body at its widest circumference could be on average in the range of 0.05 mm to 1 mm, preferably 0.2 mm to 0.6 mm, further preferably 0.3 mm to 0.5 mm or 0.2 mm to 0.5 mm, further preferably 0.2 mm to 0.45 mm, or 0.3 mm to 0.6 mm, particularly preferably 0.35 mm to 0.6 mm. Such a spacer is sufficiently small that it does not interfere visually when it is placed between two panes. In addition, it is ensured that the spacer does not form a much too large heat or cold bridge.

The main body could be substantially cylindrical, in the manner of a column and/or pillar, wherein a contact surface is provided, and wherein an average layer thickness of a deformable coating on a core material is higher in a central region than in an edge region. A coating thus protects a pane from contact with a sharp edge.

Alternatively, a contact surface with a peak in a central region could be provided, wherein a coating having a substantially homogeneous layer thickness is arranged on a core material. Thus, a coating can be applied to a core material pre-formed in a dome-like, preferably spherical-segment-like manner.

Further alternatively, a contact surface with a peak in the central region could be provided, wherein a coating with a layer thickness increased in an edge region is arranged on the core material. This combines the advantages of the first two alternatives. Preferably, the contact surface is flat.

The thickness of the coating is on average ≤30 μm, preferably ≤20 μm, further preferably ≤15 μm, further preferably ≤10 μm, further particularly preferably ≤5 μm, but always ≥0.1 μm and can vary over the surface. The coating may also have an average thickness of 5 μm±2.5 μm, 10 μm±2.5 μm or 15 μm±2.5 μm.

An arrangement comprising at least two panes, in particular glass panes, between which a spacer having a main body with two opposite contact surfaces is arranged, wherein each contact surface lies against a pane under pressure, is characterized in that each deformation zone is compressed and/or deformed in such a way that its respective contact surface is convexly curved or flattened such that it follows the curvature of the pane lying against it.

Said arrangement comprising at least two panes, in particular glass panes, between which a spacer having a main body with two opposite contact surfaces is arranged, wherein each contact surface lies against a pane under pressure, is in particular characterized in that each deformation zone is compressed and/or deformed in such a way that its respective contact surface is convexly curved or in particular flattened at the edges in relation to the center such that, following the curvature of the pane, it forms a spherical segment with a defined radius of curvature and follows a concave depression of the pane lying against it. Therefore, when a vacuum is applied in a vacuum insulating glass, the convex spherical segment formed from the contact surface of the spacer has a radius of curvature which is comparable to an equivalent radius of curvature of the concave depression which is formed in the curved pane, which is deformed under compressive stress, in the region of the contact surface of the spacer.

The dome shape assumed by the contact surface enables optimum contact conditions to be achieved. Owing to the lower maximum stress of the Hertzian pressure arising at the pane, the number of spacers can be significantly reduced compared to the prior art without reducing a safety factor. This has the technical advantage that, with fewer spacers, the heat transfer via the spacers can also be reduced as a whole.

In this respect, an arrangement with a spacer between two panes, in particular two glass panes, is specified, at which stress peaks, which may damage a pane, are reduced or avoided as far as possible. The spacer of the arrangement may be configured in a manner as disclosed in this description.

The arrangement could have a number of spacers between the two panes of 1000 to 4000, preferably 1500 to 3000, further preferably 1500 to 2500 or 300 to 3000, further preferably 750 to 2500, further preferably 1000 to 2000 or 1500 to 5000, further preferably 1500 to 3500 and particularly preferably 2000 to 3000 per m² of pane area. This ensures optimum support of the panes under optimized thermal conditions. In such an arrangement, it is possible to use relatively few spacers per unit of area to provide gentle support of the panes, and therefore fewer heat bridges are created between the panes.

The height of the spacer described here is advantageously on average in the range of 50 μm to 600 μm, preferably in the range of 100 μm to 500 μm, further preferably in the range of 100 μm to 300 μm, further preferably in the range of 100 μm to 250 μm, further preferably in the range of 50 μm to 500 μm, further preferably in the range of 50 μm to 300 μm, and particularly preferably in the range of 50 μm to 250 μm.

The quotient h2/H of the heights h2 from the highest point of the spacer (G or KG) to the highest point of an edge region of the spacer and the overall height H of the spacer advantageously lies in the range of 0 to 0.1, preferably in the range of 0 to 0.075, further preferably in the range of 0 to 0.05, further preferably in the range of 0 to 0.035, further particularly preferably in the range of 0 to 0.025, further preferably in the range of 0 to 0.02.

In principle, all possible deformation mechanisms are conceivable for deforming the deformation zone and/or the coating and/or the core material, namely elastic or plastic, the compacting or compressing of porous structures, and the simultaneous interaction of such mechanisms. A mechanism for compacting or compressing porous structures is preferred.

### IN THE DRAWING

FIG. 1 shows a schematic sectional view of a glass pane which lies under deflection against a contact area of a spacer of the prior art with a flat contact surface, wherein stress peaks form at the sharp edges of the contact surfaces,

FIG. 2 shows a schematic sectional view of a spacer with curved contact surfaces,

FIG. 3 shows a schematic sectional view of a glass pane which lies against the upper convexly curved contact surface of the spacer, wherein, at the peak of the dome of the contact surface, the glass pane presses against the contact surface under application of a very high maximum stress by Hertzian pressure and may lead to the glass breaking,

FIG. 4 shows a schematic sectional view of a curved glass pane, the curvature of which follows a contact surface curved in a dome-like manner by nesting against said contact surface, wherein, at the uppermost point or peak of the contact surface, the glass pane is subjected to a minimized maximum stress under Hertzian pressure in comparison to FIG. 3, this corresponding to an ideal placing of the glass pane onto the spacer surface,

FIG. 5 shows an arrangement with a spacer having two opposite contact surfaces, against each of which a glass pane curved as per FIG. 4 lies, in which the contact conditions as per FIG. 4 have been set,

FIG. 6 shows a perspective and geometrically schematic illustration of the upper part of a spacer which has a deformation zone with a contact surface, wherein the contact surface follows the surface of an idealized spherical cap, wherein the imaginary sphere belonging to the spherical cap has a radius of curvature r, wherein the spherical cap protrudes with a height h1 from an imaginary upper plane E of a cylindrical main body, and wherein the cylindrical main body has a diameter of 2a at its largest circumference,

FIG. 7 shows a schematic sectional view of a spacer with an overall height H, the core material of which is covered with a coating in a dome-like manner, the coating forming a deformation zone which, starting from a structure, into or over which an imaginary spherical cap with a radius of curvature r, illustrated by a solid line, can be inserted, can be brought into an actual spherical cap with an end radius of curvature R, illustrated by a dashed line,

FIG. 8 shows a schematic sectional view of a spacer with an overall height H, the core material of which is covered only in certain regions on a smooth plane with a coating which belongs to a deformation zone which, starting from a structure, onto or into which an imaginary spherical cap with a radius of curvature r, illustrated by a solid line, can be placed, can be brought into an actual spherical cap with an end radius of curvature R, illustrated by a dashed line,

FIG. 9 shows a schematic sectional view of a spacer with an overall height H, the core material of which is completely covered on a stepped plane with an axially outwardly plane and non-stepped coating, wherein the coating together with the core material forms a deformation zone which, starting from a structure, into which an imaginary spherical cap with a radius of curvature r, illustrated by a solid line, can be inserted, can be brought into an actual spherical cap with an end radius of curvature R, illustrated by a dashed line,

FIG. 10 shows a schematic sectional view of a spacer with an overall height H, the core material of which is covered on a stepped plane with a coating which is not stepped outwardly and is aligned with a core material dome only in an edge region of the core material, wherein the coating together with the core material forms a deformation zone, which, starting from a structure, into which an imaginary spherical cap with a radius of curvature r, illustrated by a solid line, can be inserted, can be brought into an actual spherical cap with an end radius of curvature R, illustrated by a dashed line,

FIG. 11 shows a schematic sectional view of a spacer with an overall height H, the core material of which is completely covered on an axially outer and stepped plane with a coating stepped axially outward, wherein the coating together with the core material forms a deformation zone which, starting from a structure, into which an imaginary spherical cap with a radius of curvature r, illustrated by a solid line, can be inserted, can be brought into an actual spherical cap with an end radius of curvature R, illustrated by a dashed line,

FIG. 12 shows a schematic sectional view of a spacer, the core material of which is provided with grooves extending axially inward from a non-stepped plane of the core material, wherein the depths of said grooves increase radially outward, wherein, on the non-stepped plane, an axially outwardly non-stepped, flat coating is applied, which has already penetrated the grooves as far as their base, and wherein the coating together with the core material forms a deformation zone which, starting from a structure, into which an imaginary spherical cap with a radius of curvature r, illustrated by a solid line, can be inserted, can be brought into an actual spherical cap with an end radius of curvature R, illustrated by a dashed line,

FIG. 13 shows a schematic sectional view of a spacer, the core material of which is provided with grooves extending axially inward from a non-stepped plane with the same depth in each case, wherein the distances between the grooves decrease radially outward, wherein, on the non-stepped plane, an axially outwardly flat coating is applied, which has already penetrated the grooves as far as their base, and wherein the coating together with the core material forms a deformation zone which, starting from a structure, into which an imaginary spherical cap with a radius of curvature r, illustrated by a solid line, can be inserted, can be brought into an actual spherical cap with an end radius of curvature R, illustrated by a dashed line,

FIG. 14 shows, in the upper view, a sectional view of a ceramic plate with a circumferential groove, into which a first layer of the coating is inserted, wherein a second layer of the coating is applied to the first layer, which second layer substantially covers the entire surface of the ceramic plate, and shows, in the lower view, a spacer which is cut out of the ceramic plate and is similar in its construction to that shown in FIG. 9,

FIG. 15 shows a spacer which is similar in its construction to that shown in FIG. 11,

FIG. 16 shows schematically, in the uppermost view, a top view of a ceramic plate into which a groove is inserted and, in the lower view, a sectional view of the ceramic plate with a groove through the groove,

FIG. 17 shows schematically, in the upper view, a top view of a ceramic plate into which a groove is inserted and, in the lower view, a top view of the ceramic plate, with a first layer of the coating having been inserted,

FIG. 18 shows, in the upper view, a sectional view of the ceramic plate with a groove through the groove with a coating inserted and, in the lower view, a sectional view of a blank which has been cut out from the ceramic plate along the outer circumference of the groove from the ceramic plate, such that a circumferential step, which is filled with the coating, is created at the edge of the blank,

FIG. 19 shows, in the upper view, a top view of a still uncoated ceramic plate into which concentric grooves are inserted as recesses on opposite sides of the plate and, in the lower view, a sectional view through the ceramic plate,

FIG. 20 shows, in the upper view, a top view of the ceramic plate according to FIG. 19, wherein the grooves on both sides are filled with a first layer of a coating and, in the lower view, a sectional view through the ceramic plate,

FIG. 21 shows, in the upper view, a top view of the ceramic plate according to FIG. 20 which has two flat second layers of a coating, which are applied to the ceramic plate according to FIG. 20 and the first layers of which are applied to the coating and, in the lower view, a sectional view through the ceramic plate,

FIG. 22 shows, in the upper view, a top view of two spacers which are cut out of the ceramic plate according to FIG. 21 and, in the lower view, a sectional view through the two spacers,

FIG. 23 shows an arrangement in which a spacer according to FIG. 22 is arranged between two panes,

FIGS. 24a, b show a schematic top view of the surface of further spacers, into which various meandering recesses or structures are introduced, such as blind holes lying concentrically on the contact surface with the same diameter and increasing number toward the edge, blind holes lying concentrically on the contact surface with a diameter increasing toward the edge, cross-sectionally kidney-shaped, trapezoidal or prism-shaped grooves of different width lying concentrically on the contact surface with increasing number toward the edge, or mixed forms of the abovementioned forms, into which the coating can deviate to form a dome shape of the contact surface when a glass pane presses on the latter,

FIG. 25 shows a schematic sectional view of a spacer with an overall height H, the core material of which is covered on a smooth plane with a coating, wherein the thickness thereof decreases axially outward, wherein the coating belongs to a deformation zone which, starting from a structure, onto or into which an imaginary spherical cap with a radius of curvature r, illustrated by a solid line, can be placed, can be brought into an actual spherical cap with an end radius of curvature R, illustrated by a dashed line,

FIG. 26 shows a schematic sectional view of a spacer with an overall height H, the core material of which is completely covered with a coating on an axially outer plane following a radius of curvature and falling outwardly, wherein the coating together with the core material forms a deformation zone which, starting from a structure, into which an imaginary spherical cap with a radius of curvature r, illustrated by a solid line, can be placed, can be brought into an actual spherical cap with an end radius of curvature R, illustrated by a dashed line,

FIG. 27 shows a schematic sectional view of a spacer with an overall height H, the core material of which is completely covered with a coating on an axially outer plane following a radius of curvature and falling outwardly, wherein the thickness thereof decreases axially outward, wherein the coating together with the core material forms a deformation zone which, starting from a structure, into which an imaginary spherical cap with a radius of curvature r, illustrated by a solid line, can be placed, can be brought into an actual spherical cap with an end radius of curvature R, illustrated by a dashed line,

FIG. 28 shows an enlarged sectional view of the chain-dotted region of the spacer from FIG. 11, the core material of which has corners with rounded steps,

FIG. 29 shows an enlarged sectional view of the chain-dotted region of the spacer from FIG. 12, wherein the inlet region is wider than the groove bottom region, in particular with laser structuring, and has rounded corners.

The sectional views shown in the figures are sections through the longitudinal axes of the respective spacers, which are rotationally symmetrical. Where only one side of a spacer is shown, the axially opposite side of the spacer is optionally formed identically to the side shown. Axially opposite sides are illustrated separated from one another in some figures by dashed lines.

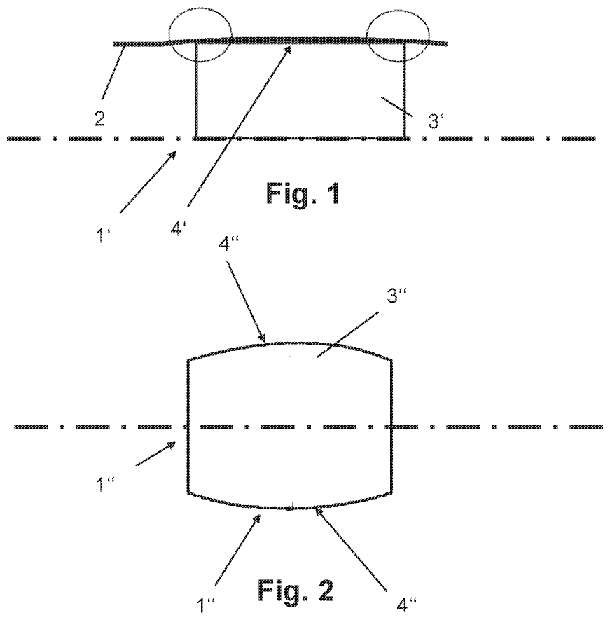

FIG. 1 shows a schematic sectional view of a glass pane 2 which lies under deflection against a contact area of a spacer 1′ of the prior art, wherein stress peaks form at the sharp edges of the opposite contact surfaces 4′.

FIG. 2 shows a schematic sectional view of a spacer 1″ without a deformation zone, which has contact surfaces 4″ curved in a dome-like manner.

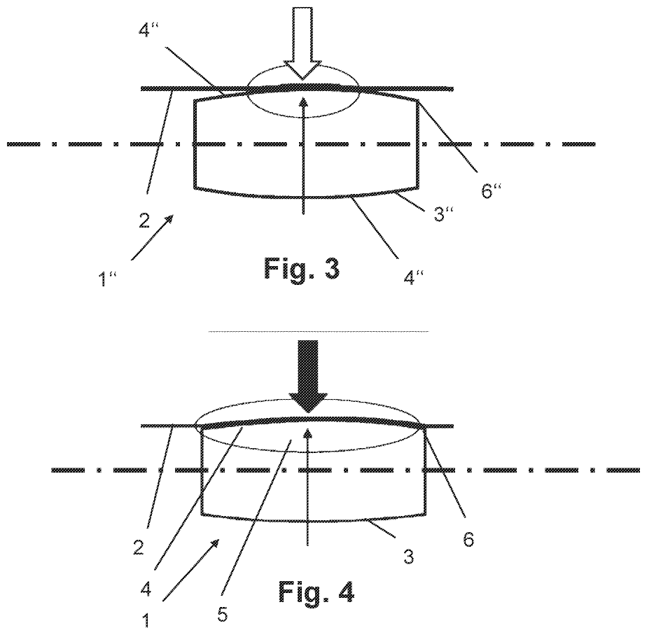

FIG. 3 shows a schematic sectional view of a glass pane 2 which lies against the upper convexly curved contact surface 4″ of the spacer 1″ according to FIG. 3, wherein, at the uppermost point of the contact surface 4″, which is in the form of a dome, the glass pane 2 presses against the contact surface 4″ when subjected to a very high maximum stress.

FIG. 4 shows a schematic sectional view of a curved glass pane 2, the concave curvature of which follows a contact surface 4, which is curved convexly in a dome-like manner, by nesting against said contact surface, wherein, at the uppermost point of the contact surface 4, which is in the form of a dome, the glass pane 2 is subjected to a minimized maximum stress under Hertzian pressure in comparison to FIG. 3 and presses against the contact surface 4. This is intended to be expressed by the fact that the ellipse lying in the contact area in FIG. 4 is illustrated clearly flattened compared to the ellipse in FIG. 3.

FIG. 4 schematically shows a spacer 1 for arrangement between two panes 2, namely for arrangement between two glass panes 2 of double-glazed or multi-glazed windows or doors, comprising a main body 3 having two axially mutually opposite contact surfaces 4 for contacting a respective pane 2. The contact surfaces 4 are formed under pressure loading by the atmospheric pressure acting on the glass panes. In the ideal case illustrated, the contact surface 4 corresponds to the dome shape of the spacer 1.

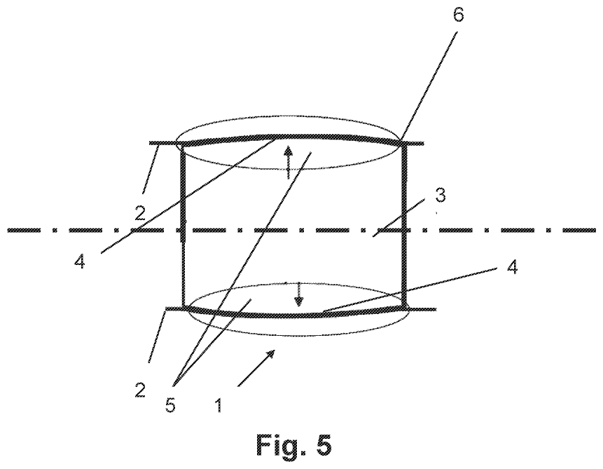

FIG. 5 shows an arrangement comprising at least two panes 2, namely two glass panes 2, between which a spacer 1 with a main body 3 with two opposite contact surfaces 4 is arranged, each contact surface 4 lying under pressure against a pane 2. In the ideal case illustrated, each contact surface 4 corresponds to the dome shape of the spacer 1.

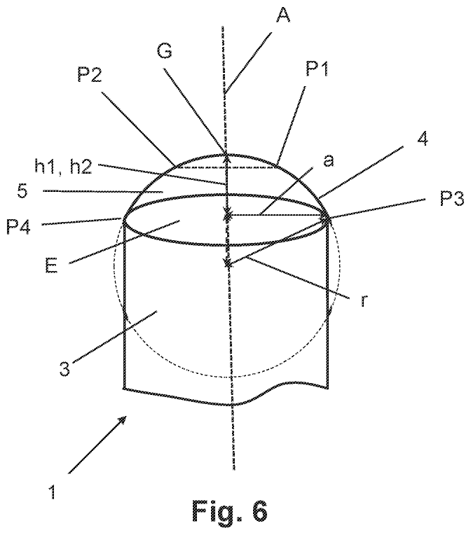

FIG. 6 shows a perspective and mathematically-geometrically schematic illustration of a spacer 1 which has a deformation zone 5 with a contact surface 4, wherein the contact surface 4 follows the surface of an idealized spherical cap. The spherical cap forms the dome shape and the imaginary sphere belonging to the spherical cap and shown in dashed lines has a radius of curvature r. The spherical cap protrudes with a height h1 from an imaginary upper, inner plane E of a main body 3, which is cylindrical in a central portion, and the main body 3, which is cylindrical in some sections, has a diameter 2a at its largest circumference.

The points P3, P4 are located in the highest edge region starting from the center plane of the spacer 1. The coating peak G of the spacer 1 protrudes axially outward over the edge region with a height h2.

The dome-forming means, which impart the dome shape to the contact surface 4, are arranged symmetrically and regularly with respect to an axis A through the center of the contact surface 4 in such a manner that they form diametrically opposite points P1, P2 with respect to the axis A, which lie on the surface of the spherical cap with the radius of curvature r.

The radius of curvature r describes, as the initial radius of curvature, a fictitious spherical cap which runs through means or functional points thereof that make it possible for the contact surface 4 to be compressible and deformable into an end form. The dome-shaped end form of the contact surface can be described by a spherical cap with an end radius of curvature R, which is shown schematically in some figures.

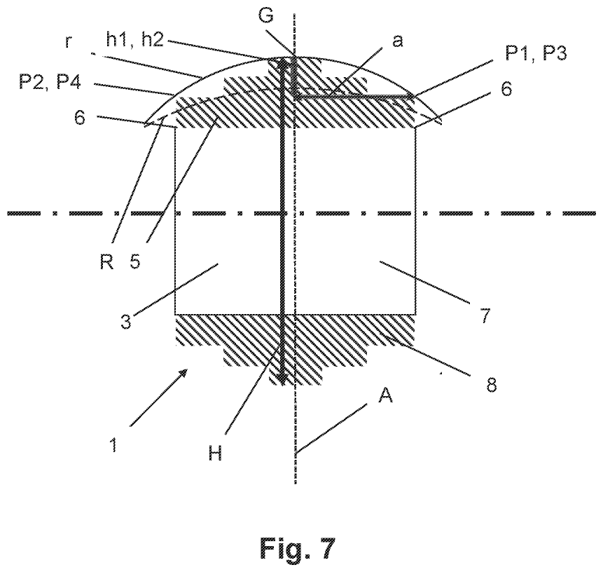

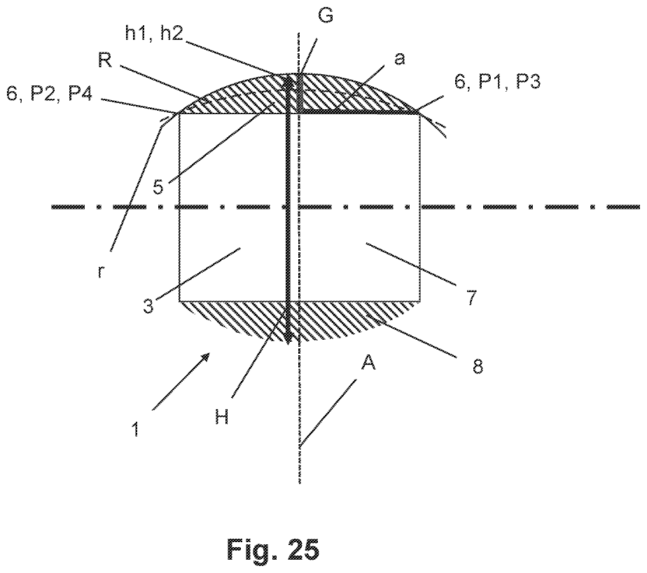

FIGS. 7 to 11 and 25 to 27 show that at least one deformable deformation zone 5 is formed, the deformation zone being assigned dome-forming means, which impart a dome shape to the contact surface 4 of the deformation zone 5. A contact surface 4 is to this extent part of the deformation zone 5. The contact surface 4 is the interface between the pane 2 and the interior of the deformation zone 5.

Each deformation zone 5 can be compressed and deformed in such a way that its respective contact surface 4 is convexly curved or flattened such that it follows the curvature of the pane 2 lying against it. Each contact surface 4 is to this extent part of a deformation zone 5.

The means guide the deformation zone 5 at least as far as the peripheral edge 6 of the main body 3 and extend the dome shape of the contact surface 4 as far as the circumferential peripheral edge 6 in such a way that the contact surface 4 is axially deformable at the peripheral edge 6, even if the edge 6 were to be virtually incompressible and sharp because of a lower-lying, hard core material 7. The pane 2 is thus not exposed to any stress peaks at the peripheral edge 6.

FIGS. 7 to 11 and 25 to 27 also show that such dome-forming means may comprise step edges or step surfaces, which are introduced in a core material 7 of the main body 3 of lower deformability and/or in a coating 8 of the core material 7 of higher deformability.

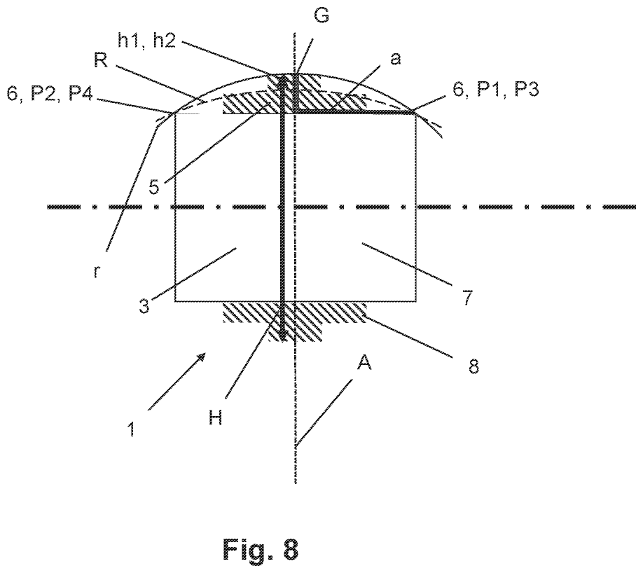

FIGS. 7 and 8 show that the deformation zone 5 comprises a coating 8 which has a higher deformability than a core material 7, wherein the means comprise coating portions or layers which follow one another in a step-like manner and gradually taper in their width toward a coating dome or coating peak G, wherein the coating dome or coating peak G forms an axially outermost coating portion, which can be turned toward a pane 2.

In FIG. 7, a flat, axially outwardly facing surface of the core material 7 is completely covered by the coating 8 and only partially covered in FIG. 8, and therefore the hard edge 6 of the main body 3 or of the core material 7 is uncovered.

FIGS. 7, 8 and 25 to this extent show a spacer 1, in which the main body 3 is formed substantially cylindrically, in the manner of a column and pillar, wherein a contact surface 4 is provided and wherein a mean layer thickness of the deformable coating 8 on the core material 7 is higher in a central region of the spacer 1 than in an edge region.

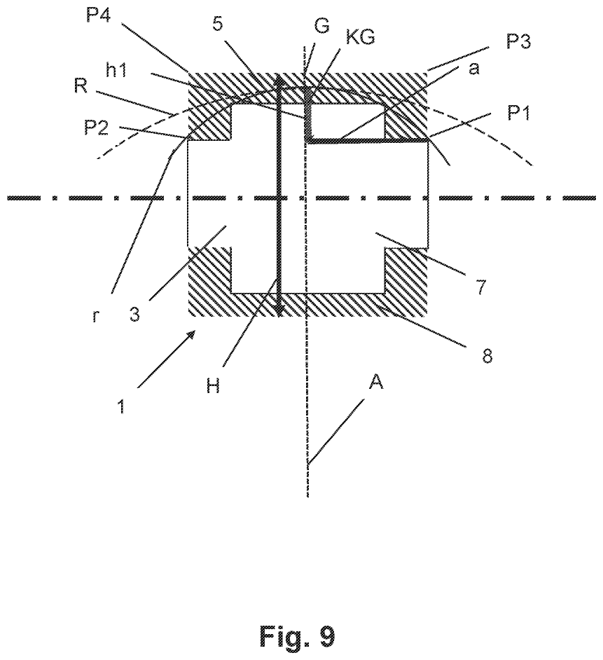

FIG. 9 shows that the deformation zone 5 comprises a coating 8 which has a higher deformability than the core material 7, wherein the means comprise core material portions which follow one another in a step-like manner and taper in their width toward a core material dome or core material peak KG, wherein the core material dome or core material peak KG forms an outermost core material portion, which can be turned indirectly toward a pane 2, wherein the coating 8 covers and surrounds the core material dome KG. The coating 8 forms a flat surface axially outward. FIG. 9 to this extent shows a contact surface 4 with a peak G in the central region, wherein a coating 8 with a layer thickness increased in an edge region is arranged on the core material 7.

The points P3, P4, and the coating peak G lie at one height. Thus, the height h2 assumes a value of 0.

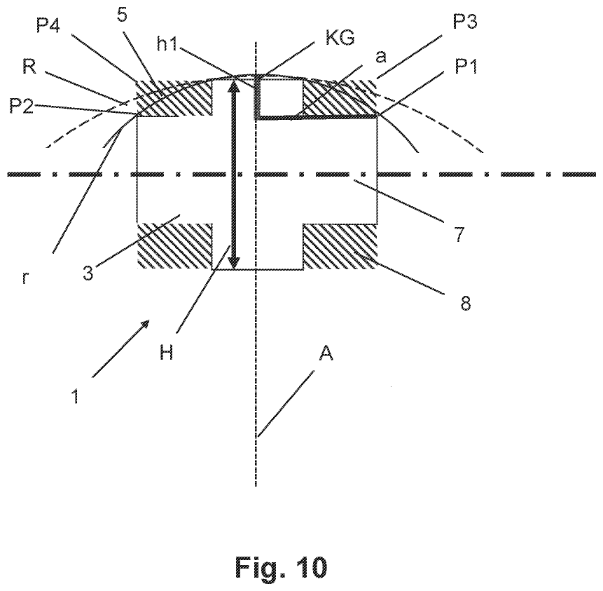

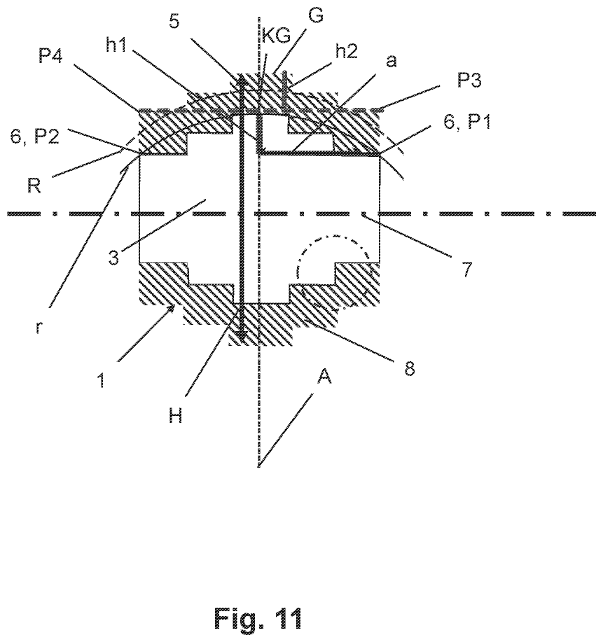

FIG. 10 shows that the deformation zone 5 comprises a coating 8 which has a higher deformability than the core material 7, wherein the means comprise core material portions which follow one another in a step-like manner and taper in their width toward a core material dome or core material peak KG, wherein the core material dome or core material peak KG forms an outermost core material portion, which can be turned directly toward a pane 2, wherein the coating 8 merely surrounds the core material dome KG and is aligned therewith, but does not cover it as in FIG. 9.

The points P3, P4, and the core material peak KG lie at one height. Thus, the height h2 assumes a value of 0.

FIG. 11 shows that the deformation zone 5 comprises a coating 8 which has a higher deformability than the core material 7, wherein the means comprise core material portions which follow one another in a step-like manner and taper in their width toward a core material dome or core material peak KG, wherein the core material dome or core material peak KG forms an outermost core material portion, which can be turned indirectly toward a pane 2, and wherein the coating 8 covers and surrounds the core material dome KG and thus forms an axially outermost coating peak G.

FIG. 11 therefore also shows that the deformation zone 5 comprises a coating 8 which has a higher deformability than the core material 7, wherein the means comprise coating portions which follow one another in a step-like manner and gradually taper in their width toward a coating dome or coating peak G, wherein the coating dome or coating peak G forms an axially outermost coating portion, which can be turned directly and immediately toward a pane 2. The coating 8 covers a plurality of core material portions and encloses them such that the edge 6 of the main body 3 or the core material 7 is covered by the coating 8. FIG. 11 to this extent shows a contact surface 4 with a peak G in a central region, wherein a coating 8 with a substantially homogeneous layer thickness is arranged on a core material 7.

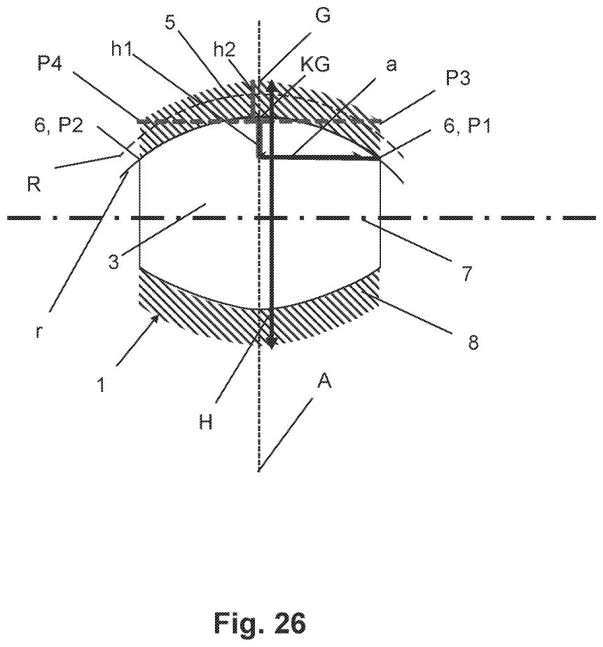

FIG. 26 shows that the deformation zone 5 comprises a coating 8 which has a higher deformability than the core material 7, wherein the means comprise, in an identical thickness, a core material, which follows a radius of curvature and falls axially outward, and taper in their width toward a core material dome or core material peak KG, wherein the core material dome or core material peak KG forms an outermost core material portion, which can be turned indirectly toward a pane 2, and wherein the coating 8 covers and surrounds the core material dome KG and thus forms an axially outermost coating peak G.

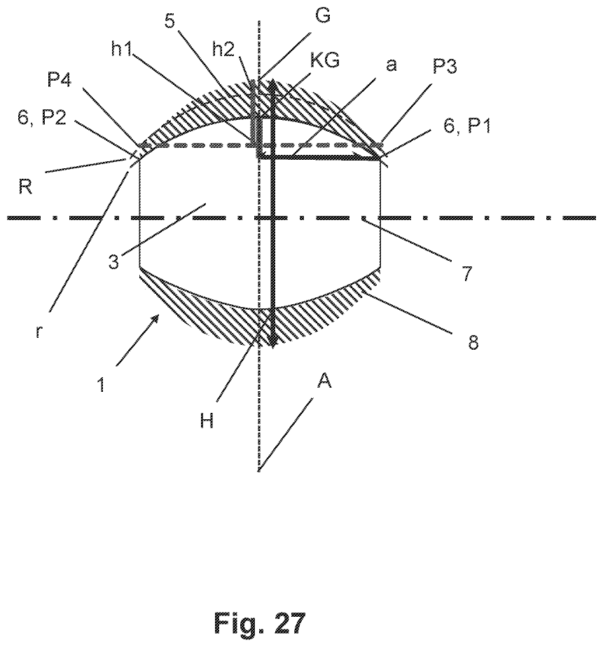

FIG. 27 shows that the deformation zone 5 comprises a coating 8 which has a higher deformability than the core material 7, wherein the means, with a thickness falling axially outward, comprise a core material, which follows a radius of curvature and falls axially outward, and taper in their width toward a core material dome or core material peak KG, wherein the core material dome or core material peak KG forms an outermost core material portion, which can be turned indirectly toward a pane 2, and wherein the coating 8 covers and surrounds the core material dome KG and thus forms an axially outermost coating peak G.

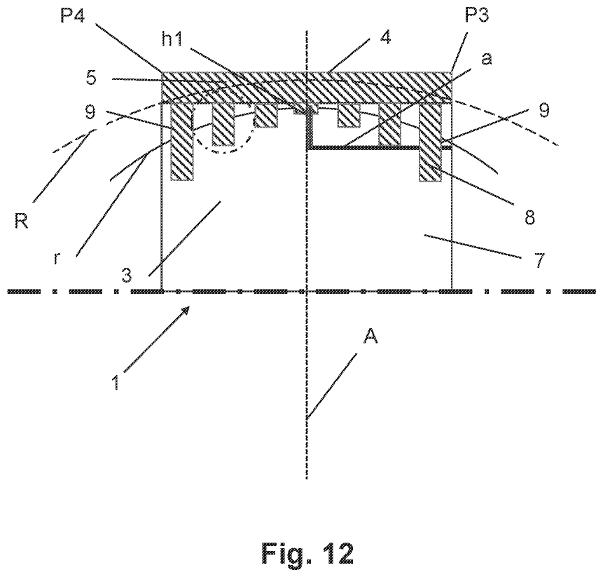

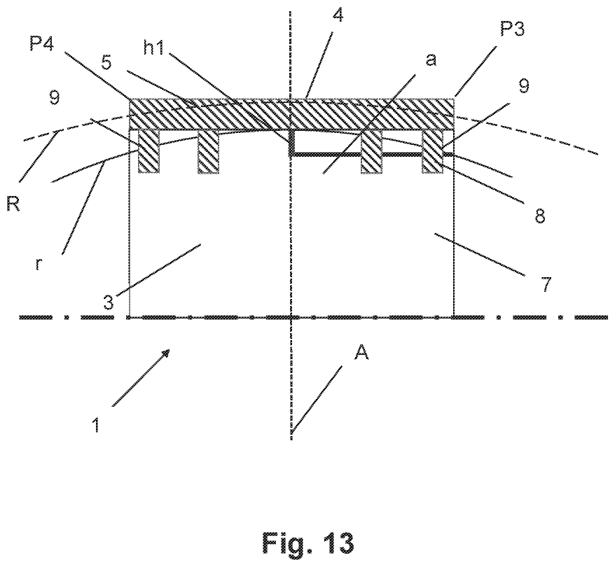

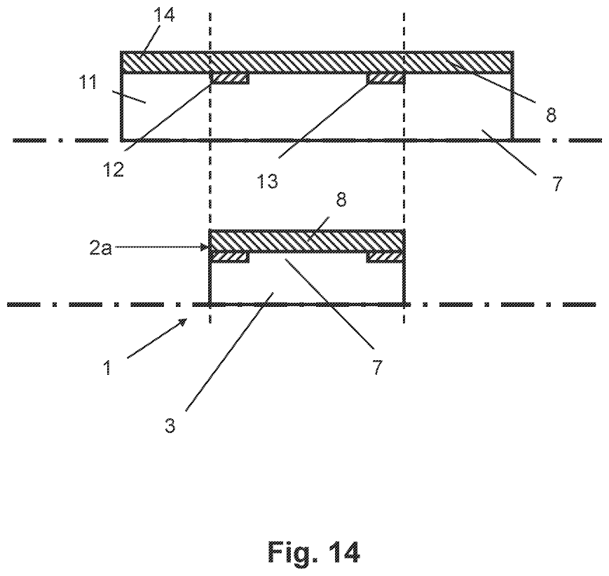

FIGS. 12 and 13 show, with reference to a relief formed intrinsically in the main body 3, that the means comprise recesses 9 which extend as grooves from a substantially flat surface of the core material 7 in its interior, wherein the recesses 9 are filled with a coating 8 on the core material 7 and wherein the coating 8 has a higher deformability than the core material 7.

FIG. 12 shows that the depth of the recesses 9 increases radially and laterally outward from a center of the contact surface 4.

FIG. 13 shows that the depth of the recesses 9 is constant, but the distance between them becomes smaller radially and laterally outward.

A deformation zone 5 described here may be formed by the coating 8 alone or in interaction with the core material 7.

The core material 7 described here comprises a ceramic, in particular a ceramic comprising zirconium oxide. The coating 8 comprises a microporous material, namely a microporous ceramic sol-gel material.

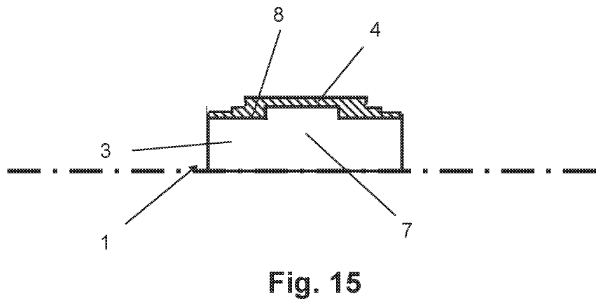

FIG. 14 shows one possible method for producing a body shown, for example, in FIG. 9. In the upper view, a sectional view of a ceramic plate 11 with a circumferential groove 12 is shown, into which a first layer 13 of the coating 8 is introduced, wherein a second layer 14 of the coating 8 is applied to the first layer 13, said second layer substantially covering the entire surface of the ceramic plate 11. In the lower view, FIG. 14 shows a sectional view of a spacer 1 which is cut out from the ceramic plate 11 and is similar in its construction to that shown in FIG. 9. FIG. 15 shows a spacer 1 which is similar in its construction to that shown in FIG. 11.

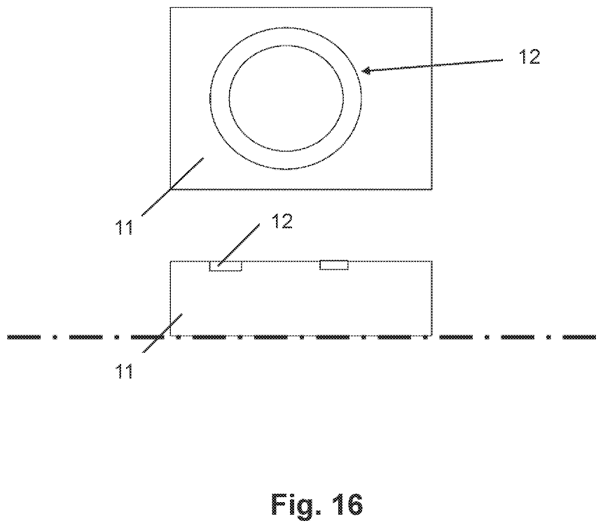

FIG. 16 shows schematically, in the upper view, a top view of a ceramic plate 11 into which a groove 12 is inserted and, in the lower view, a sectional view of the ceramic plate 11 with a groove 12 through the groove 12.

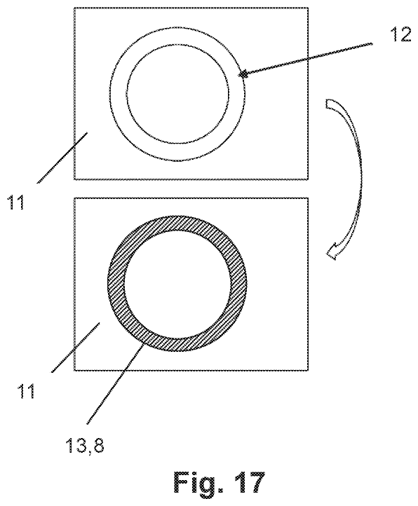

FIG. 17 shows one possible method for producing a body shown, for example, in FIG. 10. The upper view schematically shows a top view of the ceramic plate 11 into which the groove 12 is inserted and the lower view shows a top view of the ceramic plate 11, with a first layer 13 of the coating 8 having been inserted into the groove 12.

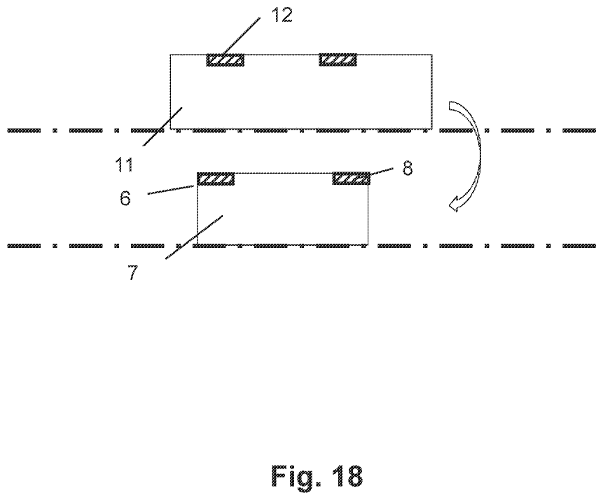

FIG. 18 shows, in the upper view, a sectional view of the ceramic plate 11 with a groove 12 through the groove 12 with a coating 8 inserted and, in the lower view, a sectional view of a blank which has been cut out from the ceramic plate 11 along the outer circumference of the groove 12 from the ceramic plate 11, such that a circumferential step, which is filled with the coating 8, is created at the edge of the body. The hard edge 6 of the core material 7 is thus covered by coating 8.

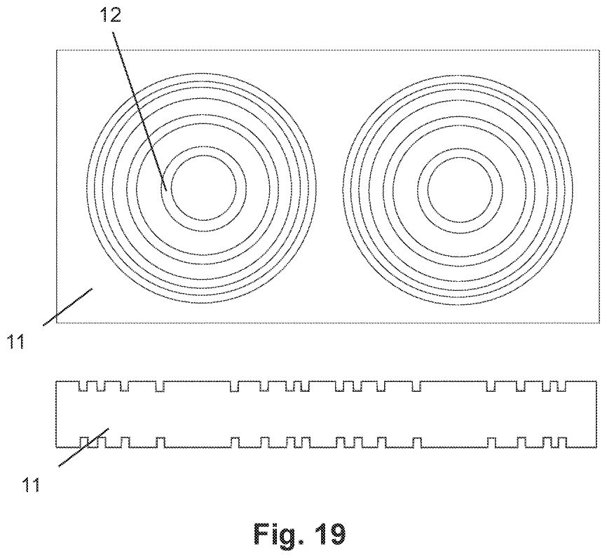

FIG. 19 shows, in the upper view, a top view of a still uncoated ceramic plate 11 into which concentric grooves 12 are inserted as recesses on opposite sides of the plate 11 and, in the lower view, a sectional view through the ceramic plate 11. The depth and width of the grooves 12 can be varied. Also, grooves 12 can be replaced by concentrically arranged blind holes or other types of depressions or mixed forms thereof. Also, the upper and lower sides of the ceramic plate 11 do not have to be structured in a mirror-symmetrical form with respect to each other.

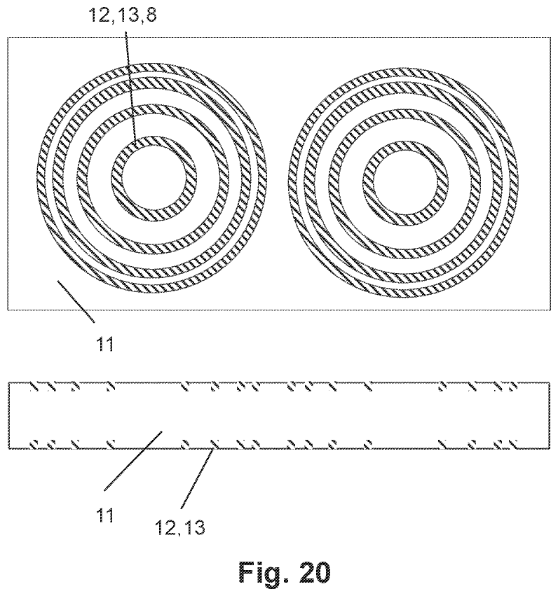

FIG. 20 shows, in the upper view, a top view of the ceramic plate 11 according to FIG. 19, wherein the grooves 12 on both sides are filled with a first layer 13 of a coating 8 and, in the lower view, a sectional view through the ceramic plate 11.

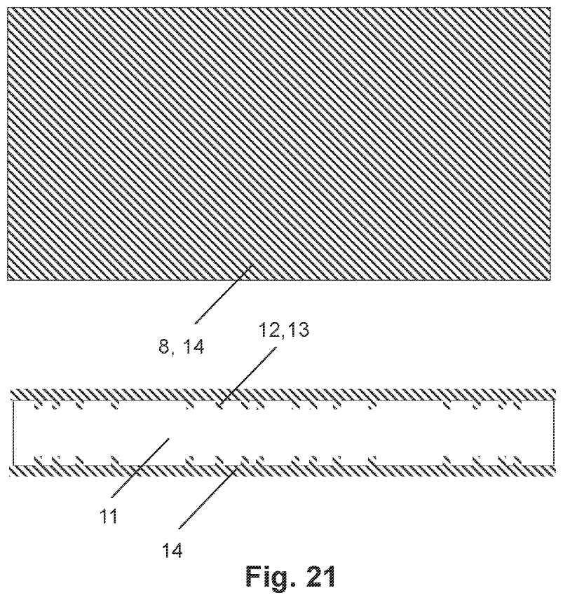

FIG. 21 shows, in the upper view, a top view of the ceramic plate 11 according to FIG. 20 which has two flat second layers 14 of a coating 8, which are applied to the ceramic plate according to FIG. 20 and the first layers 13 of which are applied to the coating 8 and, in the lower view, a sectional view through the ceramic plate 11.

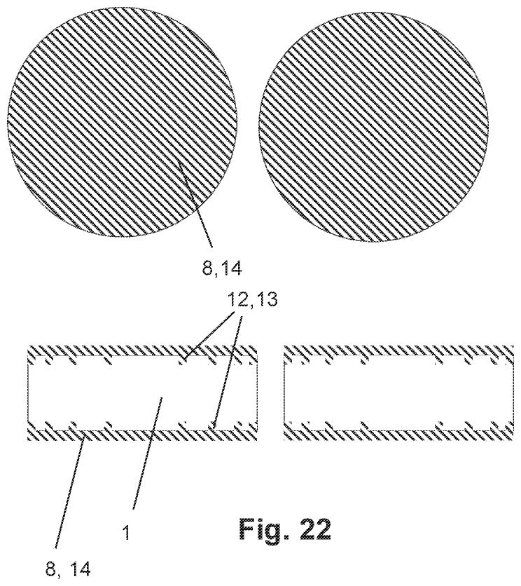

FIG. 22 shows, in the upper view, a top view of two spacers 1 which are cut out of the ceramic plate 11 according to FIG. 21 and, in the lower view, a sectional view through the two spacers 1.

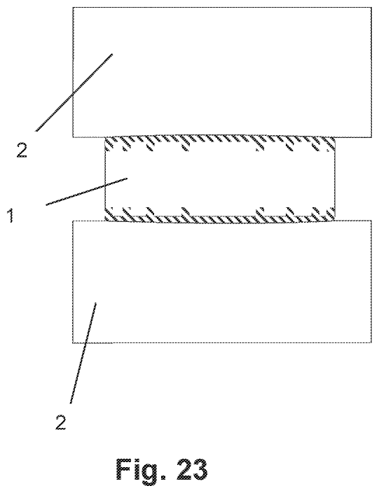

FIG. 23 shows an arrangement in which a spacer 1 according to FIG. 22 is arranged between two panes 2.

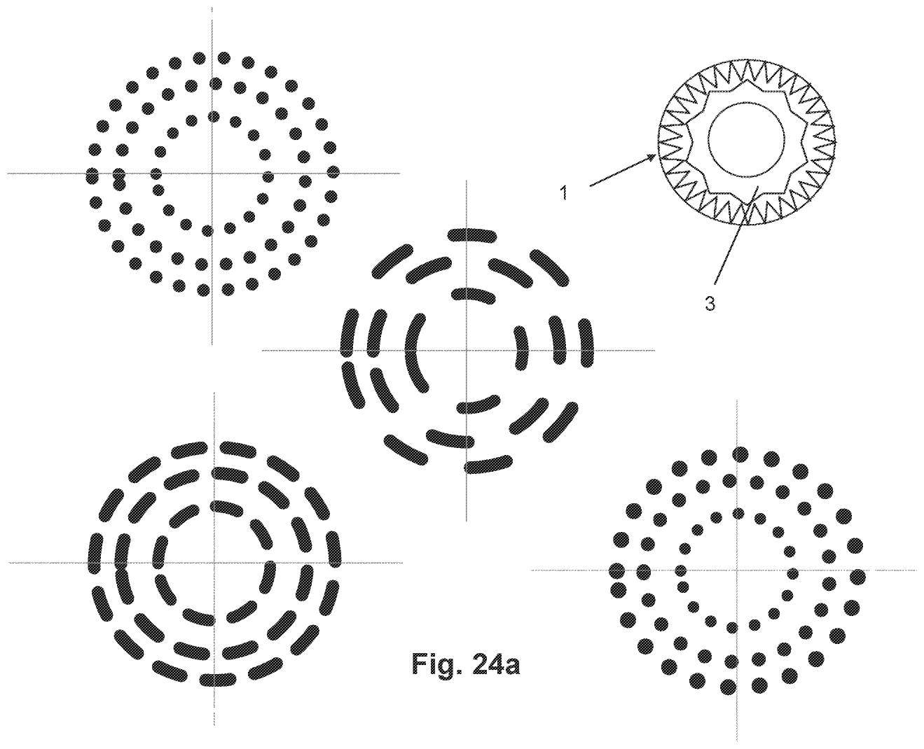

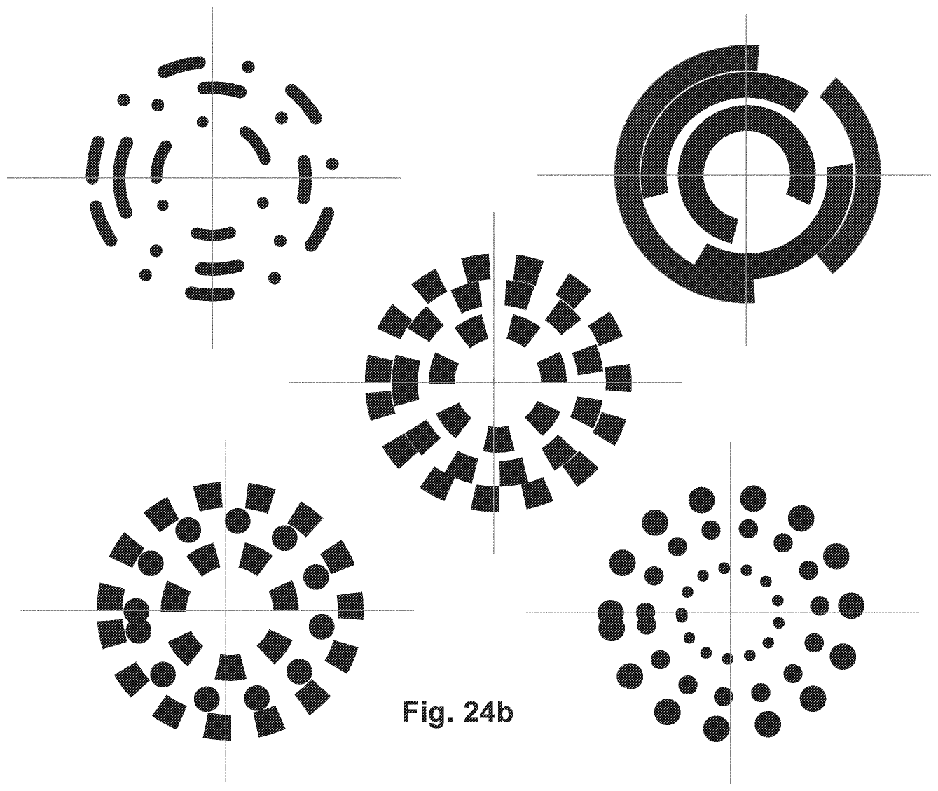

FIGS. 24a, b show schematic top views of the surface of another spacer 1, into which various meandering recesses or structures are introduced, into which the coating can deviate to form a dome shape of the contact surface when a glass pane presses on said contact surface. These recesses can be, for example, blind holes lying concentrically on the contact surface with the same diameter and increasing number toward the edge, blind holes lying concentrically on the contact surface with a diameter increasing toward the edge, kidney-shaped, trapezoidal or prism-shaped grooves of different width lying concentrically on the contact surface with increasing number toward the edge, or mixed forms of the abovementioned forms.

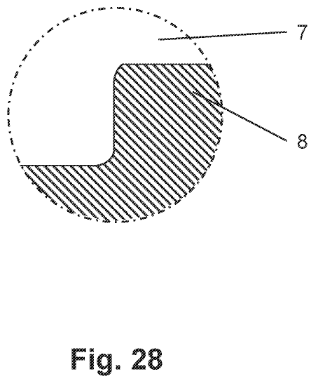

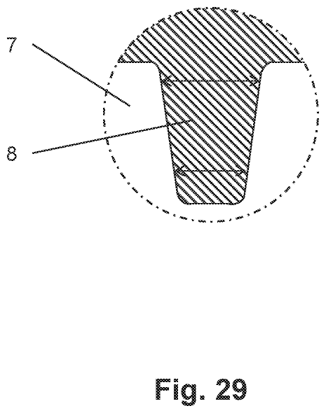

FIG. 28 and FIG. 29 show enlarged top views of steps and grooves. Rounded corners lead to a reduction in stress peaks on the core material 7. A wider groove inlet region compared to the groove bottom region facilitates a homogeneous, seamless coating.

A spacer 1 of the type described here can be produced by way of example according to the following method.

The method comprises the following steps:
providing a plate 11, here specifically a ceramic plate 11,
introducing at least one groove 12 into the plate 11, here specifically by laser radiation,
coating the groove 12 and/or the region of the plate 11 that is surrounded by the groove 12 and/or engages over the latter, in one or more steps with the coating 8,
cutting out a spacer 1 from the plate 11, in particular along a circumferential outer edge of the groove base of a groove 12, to form a step in the edge region of the spacer 1.

The method is described in more detail below, specifically with reference to FIGS. 19 to 22:

FIG. 19 shows, in the upper view, that, in order to produce the spacer 1, a plate 11, here specifically a ceramic plate 11 made of zirconium oxide, is provided.

A plurality of concentrically arranged grooves 12 are introduced into said plate 11 on both sides by laser radiation. Then, according to FIG. 20, the grooves 12 are coated with a first layer 13 of the coating 8, after which the filled grooves 12 and the previously uncoated region of the plate 11 are covered in a further step according to FIG. 21 with a second layer 14 of the coating 8. The coating 8 of the first layers 13 in the grooves 12 and the second layer 14 are connected to one another in an integrally bonded manner and form a cohesive material.

As a final step, according to FIG. 22, the spacer 1 is cut out of the coated plate 11 along a circumferential outer edge of a groove base of a groove 12 by laser radiation. This has resulted in the rotationally symmetrical spacer 1.

Specific exemplary embodiments for the production of spacers are given below:

### Production of the Spacers

### Example A1

A ceramic film made of 3Y TZP ZrO₂ with a thickness of 200 μm and an external dimension of 100 mm×100 mm is presented.

The film surfaces are structured in accordance with example O (selection from O1 to O7).

A sol-gel coating according to example B (selection from B1 to B6) is then applied on both sides such that the surfaces of the ceramic film, including the structuring, are coated. The production of the underlying sol is described in example S (selection from S1 to S7).

The circular spacers with an outer diameter of 500 μm are cut out along the outer diameter (Monaco 1035, from Coherent, 270 fs, 15 W, 250 kHz, 2100 mm/s, 400 passes, double line).

### Example A2

A ceramic film made of ZTA Al₂O₃ with a thickness of 250 μm and an external dimension of 100 mm×100 mm is presented.

The film surfaces are structured in accordance with example O (selection from O1 to O7).

A sol-gel coating according to example B (selection from B1 to B6) is then applied on both sides such that the surfaces of the ceramic film, including the structuring, are coated. The production of the underlying sol is described in example S (selection from S1 to S7).

The circular spacers with an outer diameter of 500 μm are cut out along the outer diameter.

### Example A3

A glass film made of borosilicate (AF 32® eco, from Schott) with a thickness of 200 μm and an external dimension of 100 mm×100 mm is presented.

The film surfaces are structured in accordance with example O (selection from O1 to O7).

A sol-gel coating according to example B (selection from B1 to B6) is then applied on both sides such that the surfaces of the glass film, including the structuring, are coated. The production of the underlying sol is described in example S (selection from S1 to S7).

The circular spacers with an outer diameter of 500 μm are cut out along the outer diameter.

### Example A4

A porous ceramic film made of Al₂O₃ (residual porosity 20%, average pore size 2 μm) with a thickness of 250 μm and an external dimension of 100 mm×100 mm is presented.

The film surfaces are structured in accordance with example O (selection from O1 to O7).

A sol-gel coating according to example B (selection from B1 to B6) is then applied on both sides such that the surfaces of the ceramic film, including the structuring, are coated. The production of the underlying sol is described in example S (selection from S1 to S7).

The circular spacers with an outer diameter of 500 μm are cut out along the outer diameter.

### Example A5

A stainless steel film of 1.4301 with a thickness of 200 μm and an external dimension of 100 mm×100 mm is presented.

The film surfaces are structured in accordance with example O (selection from O1 to O7).

A sol-gel coating according to example B (selection from B1 to B6) is then applied on both sides such that the surfaces of the stainless steel film, including the structuring, are coated. The production of the underlying sol is described in example S (selection from S1 to S7).

The circular spacers with an outer diameter of 500 μm are cut out along the outer diameter.

### Example A6

A film according to example A (selection from A1 to A5) is structured on both sides according to example O (selection from O1 to O7).

A sol-gel coating according to example B (selection from B1 to B6) is then applied on both sides such that the surfaces of the ceramic film, including the structuring, are coated. The production of the underlying sol is described in example S (selection from S1 to S7).

The coated film surfaces are structured in accordance with example O (selection from O1 to O7).

The circular spacers with an outer diameter of 500 μm are cut out along the outer diameter.

### Example A7

A sol-gel coating according to example B (selection from B1 to B6) is applied on both sides of a film according to example A (selection from A1 to A5). The production of the underlying sol is described in example S (selection from S1 to S7).

The coated film surfaces are structured in accordance with example O (selection from O1 to O7).

The circular spacers with an outer diameter of 500 μm are cut out along the outer diameter.

### Production of the Surface Structure

### Example O1

Annular grooves with a depth of 2 μm, a width of 25 μm and an outer radius of 250 μm are introduced in the center of the film with a laser at ten adjacent locations (Monaco 1035, from Coherent; the following parameters were used for ZrO₂: 270 fs, 4 W, 108 kHz, 500 mm/s, 1 pass, single line). Additional annular grooves with an outer radius of 150 μm, a depth of 2 μm and a width of 25 μm are introduced centered within the first annular grooves.

The process is repeated on the rear side of the film in exactly the same positions such that the annular grooves on the upper side and lower side of the film are exactly opposite one another.

### Example O2

Annular grooves with a depth of 3 μm, a width of 25 μm and an outer radius of 200 μm are introduced in the center of the film with a laser at ten adjacent locations. Additional annular grooves with an outer radius of 100 μm, a depth of 2 μm and a width of 25 μm are introduced centered within the first annular grooves. Blind holes with a depth of 1 μm and a diameter of 25 μm are introduced centered within the first two annular grooves.

The process is repeated on the rear side of the film in exactly the same positions such that the grooves on the upper side and lower side of the film are exactly opposite one another.

### Example O3

Annular grooves with a depth of 1 μm, a width of 30 μm and an outer radius of 265 μm are introduced in the center of the film with a laser at ten adjacent locations. A gradual removal is generated by laser beam shaping centered within the annular grooves. Higher thicknesses remain in the center of the annular grooves than in the outer region.

The process is repeated on the rear side of the film in exactly the same positions such that the annular grooves on the upper side and lower side of the film are exactly opposite one another.

### Example O4

Annular grooves with a depth of 1 μm, a width of 30 μm and an outer radius of 265 μm are introduced in the center of the film with a laser at ten adjacent locations. A gradual removal is generated by laser beam shaping centered within the annular grooves. Higher thicknesses remain in the center of the annular grooves than in the outer region.

A structuring is created on the rear side of the film starting from the centers of the previously introduced annular grooves. Annular grooves with a depth of 2 μm, a width of 25 μm and an outer radius of 250 μm are introduced on the rear side of each annular groove with a laser. Additional annular grooves with an outer radius of 150 μm, a depth of 2 μm and a width of 25 μm are introduced centered within said annular grooves.

### Example O5

Annular grooves with a depth of 1 μm, a width of 30 μm and an outer radius of 265 μm are introduced in the center of the film with a laser at ten adjacent locations. Centered within the annular grooves, 35 blind holes with a radius of 13 μm and a depth of 2 μm are introduced lying at an equal distance from one another on an outer radius of 200 μm. Centered within the annular grooves, a further 26 blind holes with a radius of 13 μm and a depth of 2 μm are introduced lying at an equal distance from one another on an outer radius of 150 μm.

The process is repeated on the rear side of the film in exactly the same positions such that the annular grooves on the upper side and lower side of the film are exactly opposite one another.

### Example O6

Annular grooves with a depth of 1 μm, a width of 30 μm and an outer radius of 265 μm are introduced in the center of the film with a laser at ten adjacent locations. Centered within the annular grooves, 35 blind holes with a radius of 13 μm and a depth of 3 μm are introduced lying at an equal distance from one another on an outer radius of 200 μm. Centered within the annular grooves, a further 17 blind holes with a radius of 13 μm and a depth of 2 μm are introduced lying at an equal distance from one another on an outer radius of 100 μm. Centered within the annular grooves, additional blind holes with a radius of 13 μm and a depth of 1 μm are introduced.

The process is repeated on the rear side of the film in exactly the same positions such that the annular grooves on the upper side and lower side of the film are exactly opposite one another.

### Example O7

Annular grooves with a depth of 1 μm, a width of 30 μm and an outer radius of 265 μm are introduced in the center of the film with a laser at ten adjacent locations. Centered within the annular grooves, 20 blind holes with a radius of 25 μm and a depth of 2 μm are introduced lying at an equal distance from one another on an outer radius of 200 μm. Centered within the annular grooves, a further 12 blind holes with a radius of 20 μm and a depth of 2 μm are introduced lying at an equal distance from one another on an outer radius of 100 μm. Centered within the annular grooves, additional blind holes with a radius of 13 μm and a depth of 2 μm are introduced.

The process is repeated on the rear side of the film in exactly the same positions such that the annular grooves on the upper side and lower side of the film are exactly opposite one another.

### Production of the Sol

### Example S1

60 g of boehmite (PB 950, from PIDC, particle size 5 μm to 15 μm, crystallite size 3 nm to 5 nm) are mixed with 400 g of demineralized water and stirred with an electric agitator for 10 min. The suspension is then heated to 85° C. to 90° C. and continuously stirred further. After the suspension has reached the desired temperature, a total of 19 g of a 65% strength HNO₃ acid is slowly added with a pipette and stirred in. By addition of HNO₃, the suspension firstly clears up slightly before the viscosity increases and the mixture becomes strongly gelled.

The resulting gel is cooled in air to room temperature.

When the suspension is heated, some of the water evaporates. The evaporated quantity is determined by weighing before and after heating. The evaporated water is added and stirred into the gel.

Aluminum oxide (CT 3000 SG, from Almatis, mean particle size 0.5 μm) in a ratio of 8:1 in relation to the boehmite mass and an organic binder (Optapix C95, from Zschimmer und Schwarz) with a quantity of 5% based on the total solid mass of boehmite and Al₂O₃ are added to the gel and ground in an attritor mill.

A required dilution before application is carried out with demineralized water.

### Example S2

60 g of boehmite (PB 950, from PIDC, particle size 5 μm to 15 μm, crystallite size 3 nm to 5 nm) are mixed with 400 g of demineralized water and stirred with an electric agitator for 10 min. The suspension is then heated to 85° C. to 90° C. and continuously stirred further. After the suspension has reached the desired temperature, a total of 19 g of a 65% strength HNO₃ acid is slowly added with a pipette and stirred in. By addition of HNO₃, the suspension firstly clears up slightly before the viscosity increases and the mixture becomes strongly gelled. The resulting gel is cooled in air to room temperature.

When the suspension is heated, some of the water evaporates. The evaporated quantity is determined by weighing before and after heating. The evaporated water is added and stirred into the gel.

Aluminum oxide (CT 3000 SG, from Almatis, mean particle size 0.5 μm) in a ratio of 1:1 in relation to the boehmite mass and an organic binder (Optapix C95, from Zschimmer und Schwarz) with a quantity of 5% based on the total solid mass of boehmite and Al₂O₃ are added to the gel and ground in an attritor mill.

A required dilution before application is carried out with demineralized water.

### Example S3

Aluminum oxide (CT 3000 SG, from Almatis) is added to water glass (sodium silicate, from Carl Roth) in a ratio of 1:1 in relation to the mass and ground in an attritor mill.

A required dilution before application is carried out with demineralized water.

### Example S4

A ready-to-use sol-gel binder (ino®decor basis+, from inomat) is used.

A required dilution before application is carried out with ethanol.

### Example S5

Pyrogenic silica (HDK N20, from Wacker-Chemie) is added to the binder from example S4 in a ratio of 1:20 in relation to the suspension mass, incorporated by means of an agitator unit and then dispersed by means of Ultra Turrax (from IKA).

A required dilution before application is carried out with ethanol.

### Example S6

100 g of tetraethoxysilane (TEOS, from ABCR) are mixed with 20 g of perfluoropolyether (PFPE, Fluorolink® S10, Solvay Solexis), 40 g of demineralized water, 30 g of isopropanol and 0.2 g of hydrogen chloride and stirred with an electric agitator for 30 min. The resulting suspension is then diluted with 275 g of isopropanol and 75 g of butyl alcohol and stirred again for 30 min.

Silica sol (DP5820, from Nyacol) with an amount of 3% based on the total solid mass of TEOS and PFPE is added to the suspension and mixed.

A required dilution before application is carried out with ethanol.

### Example S7

10% of polytetrafluoroethylene (PTFE, 50TF 5070GZ, from 3M) based on the suspension mass are added to the binder from example S2, incorporated by means of an agitator unit and then dispersed at low speeds by means of Ultra Turrax.

A required dilution before application is carried out with ethanol.

### Production of the Sol-Gel Coating

### Example B1

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

After baking, a firmly adhering layer is obtained, which can undergo a volume reduction of >20% by external action of pressure.

A circumferential edge with a width of 1 cm is discarded for further processing.

### Example B2

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

A solid mass content of 10% is set by diluting suspension S6. This is filled into an airbrush system and applied on one side with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 200° C. for 2 h.

The additional coating has a thickness of approx. 2 μm.

A circumferential edge with a width of 1 cm is discarded for further processing.

### Example B3

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

A solid mass content of 10% is set by diluting suspension S7. This is filled into an airbrush system and applied on one side with a spray pressure of 1.7 bar and at a distance of 10 cm from the film to be coated by a 0.5 mm spray nozzle. The coating is then dried in the drying oven at 60° C. for one to two days. The dried layer is baked at a heating rate of 500 K/h at 300° C. for 10 min.

The additional coating has a thickness of approx. 2 μm.

A circumferential edge with a width of 1 cm is discarded for further processing.

### Example B4

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

The baked layers are infiltrated with polytetrafluoroethylene (PTFE, 50TF 5070GZ, from 3M, diluted with demineralized water to a solid mass content of 2%) by immersion in the existing solution.

The infiltrated coating is then dried in the drying oven at 60° C. for one to two days.

A circumferential edge with a width of 1 cm is discarded for further processing.

### Example B5

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

The baked layers are infiltrated with a soot solution (Derussol® 345, from Orion Engineered Carbons, diluted with demineralized water to a solid mass content of 2%) by immersion. This facilitates the optical detectability of the spacers.

The coating is then dried in the drying oven at 60° C. for one to two days. The dried layer is baked at a heating rate of 100 K/h at 450° C. for 1 h in a nitrogen atmosphere.

A circumferential edge with a width of 1 cm is discarded for further processing.

### Example B6

By diluting suspension S (selection from S1 to S5), a solid mass content of 10% is set. This is filled into an airbrush system and applied on both sides with a spray pressure of 1.7 bar and at a distance of 10 cm from the film to be coated by a 0.5 mm spray nozzle.

The coating is then dried in the drying oven at 60° C. for one to two days. The dried layer is baked at a heating rate of 100 K/h at 450° C. for 1 h.

The coating has a thickness of approx. 2 μm.

A layer of cyclododecane (ATTBIME® AB24) is applied on one side to temporarily increase the adhesion. This makes it easier to position the spacers on the glass pane. Said layer sublimates completely and without residue under vacuum.

A circumferential edge with a width of 1 cm is discarded for further processing.

### LIST OF REFERENCE SIGNS

1 spacer
2 pane
3 main body
4 contact surface of 3
5 deformation zone of 3
6 edge of 7
7 core material of 3
8 coating of 3
9 recess of 7
11 plate
12 groove in 11
13 first layer of 8
14 second layer of 8
A axis, longitudinal axis, axis of symmetry of 3
E plane
G coating peak or coating dome of 8
KG core material peak or core material dome of 7
2a diameter of 3
P1,P2 points on dome-shaped contact surface 4
P3,P4 points on the edge region of 1
r imaginary radius of curvature of 5 before pressure loading
R actual radius of curvature of 5 after pressure loading
h1 height of 5 before pressure loading over E
h2 height of the highest point of 1 (G or KG) above the points P3,P4
H overall height of 1

1. A spacer for arrangement between two panes, in particular for arrangement between two glass panes of double-glazed or multi-glazed windows or doors, comprising a main body having two axially opposite contact surfaces for contacting a respective pane,
wherein
at least one deformable deformation zone is arranged between the contact surfaces, the deformation zone being assigned dome-forming means, which impart a dome shape to the contact surface.

2. The spacer as claimed in claim 1, wherein in that the dome-forming means guide the deformation zone at least as far as the peripheral edge of the main body and extend the dome shape of the contact surface as far as the peripheral edge in such a way that the contact surface is at least axially deformable at the peripheral edge, or in that the contact surface is spaced apart from a peripheral edge.

3. The spacer as claimed in claim 1, wherein the dome-forming means are arranged symmetrically and/or regularly with respect to an axis through the center of the contact surface such that they form points which are diametrically opposite with respect to the axis and which lie on the surface of a spherical cap or on a circular arc with a radius of curvature, which is on average in the range of 0.5 mm to 100 mm.

4. The spacer as claimed in claim 1, wherein the dome-forming means comprise step edges and/or step surfaces and/or a course following a radius of curvature, which are introduced in a core material of the main body of lower deformability and/or in a coating of the core material of higher deformability.

5. The spacer as claimed in claim 4, wherein the average thickness of the coating is ≤30 μm, preferably ≤20 μm.

6. The spacer as claimed in claim 1, wherein the quotient h2/H of the height from the highest point of the spacer to the highest point of an edge region of the spacer and the overall height of the spacer advantageously lies in the range of 0 to 0.1.

7. The spacer as claimed in claim 1, wherein the deformation zone comprises a coating which has a higher deformability than a core material, wherein the dome-forming means comprise coating portions which follow one another in a step-like manner and gradually taper in their width toward a coating dome or coating peak, wherein the coating dome or coating peak forms an axially outermost coating portion, which can be turned toward a pane.

8. The spacer as claimed in claim 1, wherein the deformation zone comprises a coating which has a higher deformability than a core material, wherein the dome-forming means comprise coating portions which follow a radius of curvature and form a coating dome or coating peak, wherein the coating dome or coating peak forms an axially outermost coating portion which can be turned toward a pane.

9. The spacer as claimed in claim 1, wherein the deformation zone comprises a coating which has a higher deformability than the core material, wherein the dome-forming means comprise core material portions which follow one another in a step-like manner and taper in their width toward a core material dome or core material peak, wherein the core material dome or core material peak forms an outermost core material portion, which can be turned toward a pane, and wherein the coating covers and/or surrounds the core material dome or core material peak.

10. The spacer as claimed in claim 1, wherein the deformation zone comprises a coating which has a higher deformability than the core material, wherein the dome-forming means comprise core material portions which follow a radius of curvature and form a core material dome or core material peak, wherein the core material dome or core material peak forms an outermost core material portion, which can be turned toward a pane, and wherein the coating covers and/or surrounds the core material dome or core material peak.

11. The spacer as claimed in claim 4, wherein the coating covers and/or encloses at least one or more core material portions.

12. The spacer as claimed in claim 1, wherein the dome-forming means comprise recesses which extend from a surface of the core material into the interior thereof, wherein the recesses are at least partially filled with a coating on the core material or can be filled by pressurization of the contact surface, wherein the coating has a higher deformability than the core material.

13. The spacer as claimed in claim 12, wherein recesses are in the form of bores, blind holes, hollows, cavities with a linear, circular, angular, serrated, meandering, helical, spiral, honeycomb-like or planar form, in the form of portions of said forms or in the form of mixed forms of the aforementioned forms.

14. The spacer as claimed in claim 12, wherein the depth and/or lateral width of the recesses and/or the lateral extensions thereof increase(s) or decrease(s) from a center of the contact surface radially and laterally outward or a course following a radius of curvature from a center of the contact surface radially and laterally outward is present.

15. The spacer as claimed in claim 1, wherein a core material comprises an inorganic material, and in that a coating comprises a microporous and/or nanoporous material.

16. The spacer as claimed in claim 1, wherein a coating is colored, electrically conductive or insulating, magnetizable, hydrophilic, hydrophobic, of the same or different density on both sides, or adhesive per se or by embedded particles.

17. The spacer as claimed in claim 1, wherein a volume reduction of the deformation zone and/or of a coating on the core material on average is in the range of 0.01 to 0.7.

18. The spacer as claimed in claim 1, wherein a diameter of the main body at its widest circumference of is on average 0.05 mm to 1 mm.

19. The spacer as claimed in claim 1, wherein the main body is formed substantially cylindrically, in the manner of a column and/or pillar and/or as a prism, wherein
a) a contact surface is provided, wherein an average layer thickness of a deformable coating on a core material is higher in a central region than in an edge region, or
b) a contact surface with a peak in a central region is provided, wherein a coating having a substantially homogeneous layer thickness is arranged on a core material, or
c) wherein a contact surface with a peak in the central region is provided, wherein a coating with a layer thickness increased in an edge region is arranged on the core material.

20. An arrangement comprising at least two panes, in particular glass panes, between which a spacer having a main body with two opposite contact surfaces is arranged, in particular as claimed in claim 1, wherein each contact surface lies against a pane under pressure, wherein each deformation zone is compressed and/or deformed in such a way that its respective contact surface is convexly curved or flattened such that it follows the curvature of the pane lying against it.

21. The arrangement as claimed in claim 20, wherein a number of spacers between two panes is 1000 to 4000 per m² of pane area.

22. The arrangement as claimed in claim 20, wherein an end radius of curvature is formed under pressure loading, which is on average ≥1 mm.
